(19) United States
(12) Patent Application Publication
(10) Pub. No.: US 2020/0313713 A1
(43) Pub. Date: Oct. 1, 2020

(54) PROTECTIVE CASE FOR MOBILE DEVICE WITH INTEGRATED LATCH

(71) Applicant: Incipio, LLC, Irvine, CA (US)

(72) Inventor: Andy Fathollahi, Corona del Mar, CA (US)

(73) Assignee: Incipio, LLC, Irvine, CA (US)

(21) Appl. No.: 16/847,658

(22) Filed: Apr. 14, 2020

Related U.S. Application Data
(63) Continuation-in-part of application No. 15/985,492, filed on May 21, 2018, now Pat. No. 10,623,041.
Application No. 15/985,492 is a continuation of application No. 15/620,804, filed on Jun. 12, 2017, now Pat. No. 9,979,430.
Application No. 15/620,804 is a continuation of application No. 15/237,502, filed on Aug. 15, 2016, now Pat. No. 9,680,519.
Application No. 15/237,502 is a continuation of application No. 14/590,975, filed on Jan. 6, 2015, now Pat. No. 9,419,670.
(60) Provisional application No. 61/924,695, filed on Jan. 7, 2014.

(51) Int. Cl. H04B 1/3888; H04B 1/3877; H04M 1/04; G06F 1/16; A45C 11/00

(52) U.S. Cl. CPC H04B 1/3888; H04B 1/3877; H04M 1/04; A45C 2200/15; A45C 11/00; G06F 2200/1633; A45C 2011/003; G06F 1/1626

(57) ABSTRACT

A protective case for a mobile device is disclosed herein. The protective case includes a front cover, a back cover, and a relatively rigid shell. The front cover includes multiple fold lines that extend across the cover and allow adjacent regions of the cover to rotate or move relative to each other. The shell is configured to receive and retain the mobile device while providing user access to the mobile device. The shell has an outer surface configured to include a latch with an integrated hook. In operation, the latch hooks and retains one end section of the front cover to maintain the device in an angled use position when open. When in the fully closed position the latch fits within an aperture defined within a back end region of the front cover. Magnets incorporated into the front cover assist in maintaining the case in the fully closed position.

### CROSS-REFERENCE TO RELATED APPLICATIONS

This application is a continuation-in-part of U.S. patent application Ser. No. 15/985,492, filed on May 21, 2018, which is a continuation of U.S. patent application Ser. No. 15/620,804, filed on Jun. 12, 2017 and issued as U.S. Pat. No. 9,979,430 on May 22, 2018, which is a continuation of U.S. patent application Ser. No. 15/237,502, filed on Aug. 15, 2016 and issued as U.S. Pat. No. 9,680,519 on Jun. 13, 2017, which is a continuation of U.S. patent application Ser. No. 14/590,975, filed on Jan. 6, 2015 and issued as U.S. Pat. No. 9,419,670 on Aug. 16, 2016, which claims the benefit of and priority to U.S. Provisional Patent Application Ser. No. 61/924,695, filed on Jan. 7, 2014, the entireties of which are hereby incorporated herein by reference.

### BACKGROUND

### Field of the Invention

The present disclosure relates to protective cases for mobile devices.

### Description of the Related Art

Mobile devices, such as smartphones, tablets, laptops, and the like, are known to sustain damage from impact and from contamination as a result of ingress of water or other fluids. The damage, for example, may result in a cracked screen, scratches on a finished surface, lost or damaged buttons or controls, cracked or bent external body components, and/or failed or malfunctioning electrical components. Protective cases are used to protect mobile devices from these and other types of damage.

It has been recognized that there is a continuing need for protective cases for mobile devices that include an integrated support latch that facilitates support of the device in a use position when the case is open and facilities a more secure closed position.

### SUMMARY

A protective case configured to receive, retain, cover, and protect a mobile device is disclosed herein. The protective case includes a front cover and a relatively rigid shell, which together are configured to receive, retain, cover, and protect the mobile device. The front cover includes multiple fold lines that extend across the cover and allow adjacent regions of the cover to rotate or move relative to each other. The shell is configured to reversibly receive and retain the mobile device while providing user access to the mobile device. The shell has an outer surface configured to include a latch with an integrated hook and magnets on opposing end regions of the front cover.

In operation, the latch hooks and retains one end section of the front cover to maintain the device in an angled use position when open. When in the fully closed position, the latch fits within an aperture defined within a back end region of the front cover. The aperture may be defined by a ring component that is dimensioned to receive the latch and firmly support the latch. Magnets incorporated into opposing ends of the front cover are provided to assist in maintaining the case in the fully closed position.

Each of the foregoing and various aspects, together with those set forth in the claims and summarized above or otherwise disclosed herein, including the drawings, may be combined to form claims for a device, apparatus, system, method of manufacture, and/or method of use.

### BRIEF DESCRIPTION OF THE DRAWINGS

The figures provided herewith are intended to illustrate but not to limit the invention. Reference numbers are re-used in the figures to indicate correspondence between referenced elements.

FIGS. 1A-1B are front and back face perspective views, respectively, of an embodiment of the disclosed protective case in the fully closed position.

FIGS. 1C-1D are rear and front side perspective views, respectively, of the protective case illustrated in FIGS. 1A-1B, wherein the protective case is in an open use position to further illustrate the configuration and constriction of the constituent components and their operation.

FIGS. 2A-2B are more detailed illustrations of the front and back face perspective views shown in FIGS. 1A-1B, respectively, of the protective case in the fully closed position.

FIG. 3 is a front face view of the embodiment of the protective case shown in FIGS. 1A-1B in the fully closed position.

FIGS. 4A-4C are detailed illustrations of the latch ring and its placement in the front cover of the embodiment of the protective case shown in FIGS. 1A-1B. FIG. 4A illustrates a perspective back view of the protective case in the open use position. FIG. 4B is a partially disassembled backside perspective view of the protective case in the fully closed position wherein the ring is disassembled from the front cover component. FIG. 4C is also a backside perspective view of the protective case in the fully closed position but further illustrates in shadow where corresponding magnets may be located on the region of the front cover configured to mate with the flap when the case is in the fully closed position.

FIG. 5 is a detailed back side perspective view illustration of the shell component of the embodiment of the protective case shown in FIGS. 1A-1B.

FIGS. 6A-6B are simplistic illustrations of front and perspective views of the protective case components of the embodiment of the protective case shown in FIGS. 1A-1B that are positioned in the open position with the front cover liner component threaded into a slot in the shell component but not attached thereto.

FIG. 7 is a plan view of the external face of the front cover of the embodiment of the protective case shown in FIGS. 1A-1B that illustrates the layout of the front cover.

### DETAILED DESCRIPTION

A protective case configured to receive, retain, cover, and protect a mobile device is disclosed herein. The protective case includes a front cover and a relatively rigid shell, which together are configured to receive, retain, cover, and protect the mobile device. The front cover includes multiple fold lines that extend across the cover and allow adjacent regions of the cover to rotate or move relative to each other. The shell is configured to reversibly receive and retain the mobile device while providing user access to the mobile device. The shell has an outer surface configured to include a latch with an integrated hook and magnets on opposing end regions of the front cover.

In operation, the latch hooks and retains one end section of the front cover to maintain the device in an angled use position when open. When in the fully closed position, the latch fits within an aperture defined within a back end region of the front cover. The aperture may be defined by a ring component that is dimensioned to receive the latch and firmly support the latch. Magnets incorporated into opposing ends of the front cover are provided to assist in maintaining the case in the fully closed position.

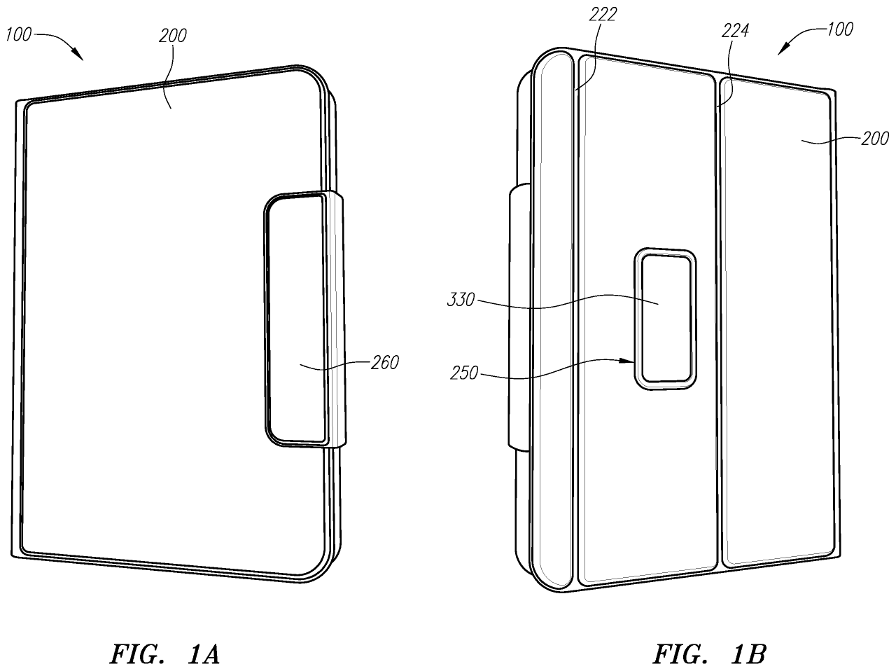

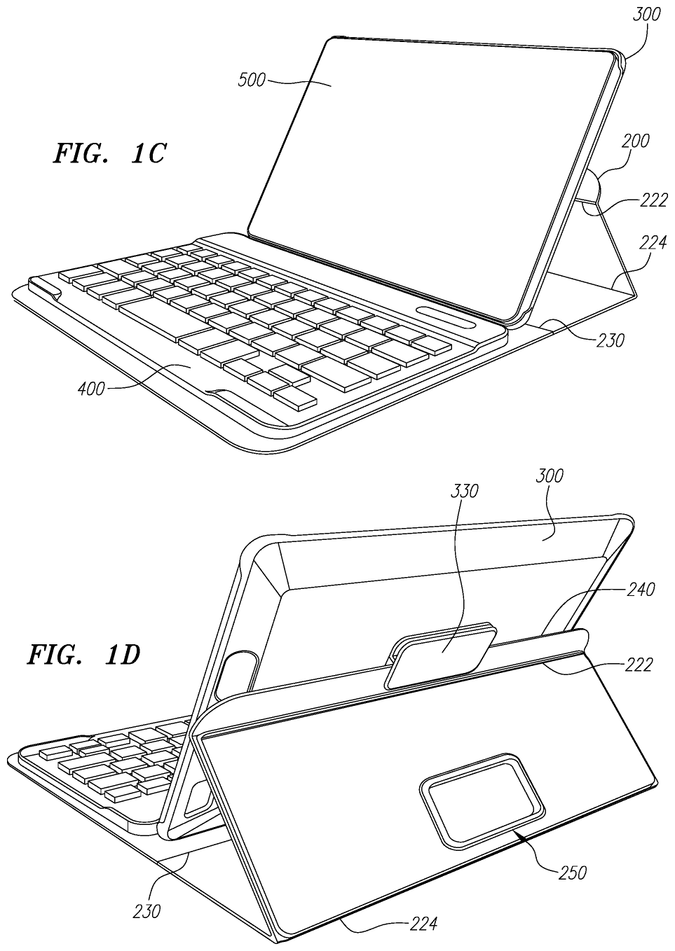

FIGS. 1-7 illustrate various aspects of an embodiment of the protective case for a mobile device in the form of an Apple iPad Mini® tablet computer. It should be understood, however, that the various aspects and teachings therein are not limited to any particular mobile device and instead have broad applicability to a variety of mobile devices.

FIGS. 1A-1B are front and back face perspective views, respectively, of the protective case 100 in the fully closed position. The protective case 100 includes a front cover component 200 and a shell component 300, which together are configured to receive, retain, cover, and protect an Apple iPad Mini® tablet computer. The shell component 300 is mostly concealed within the front cover 200 when the case is in a fully closed position. FIGS. 1C-1D are rear and front side perspective views, respectively, of the protective case 100 in an open use position that further illustrate the configuration and construction of the constituent components and their operation.

The front cover 200 includes multiple fold lines 222 and 224 that extend across the cover and allow adjacent regions of the cover to rotate along those lines. The front cover 200 may be made of one or more layers of natural or synthetic fabric, such that an outer layer may be comprised of a polyurethane fabric and internal layer may be comprised of a micro-suede fabric.

The shell component 300 is configured to receive and retain the tablet device while providing user access via apertures to the various control buttons (e.g., power, volume, etc.) and ports (e.g., headphone jacks, data and charging ports, etc.). The shell component 300 may be made of molded polycarbonate panel or wall. The shell component 300 has an inner surface 310 configured to receive and retain the tablet and an outer surface 320 configured to include a latch 330 with an integrated hook 340. When in operation, the latch hooks and retains an end section 240 of the front cover to maintain the device in an angled use position as best illustrated in FIGS. 1C-1D.

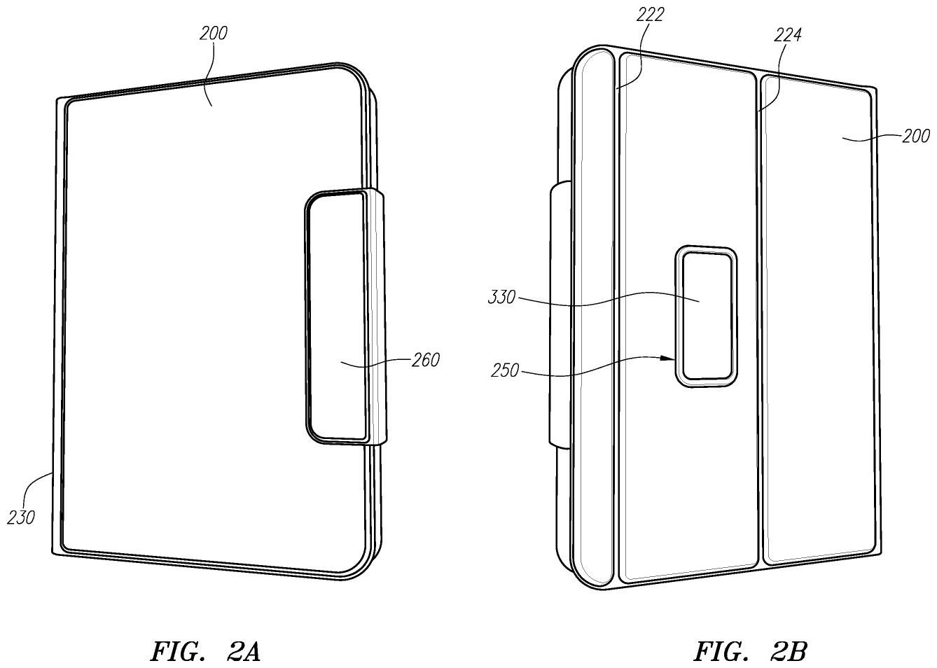

FIGS. 2A-2B are more detailed illustrations of the front and back face perspective views shown in FIGS. 1A-1B, respectively, of the protective case 100 in the fully closed position. The illustrations depict in more detail the ring 250 that defines an aperture 252 with the front cover 200 and the latch 330 that is dimensioned to fit snugly within the ring 250 when the case is in the fully closed position. The latch 330 also provides a hook 340 that engages an end section 240 of the front cover 200 in the open position to facilitate support of the device at an angled position while in use.

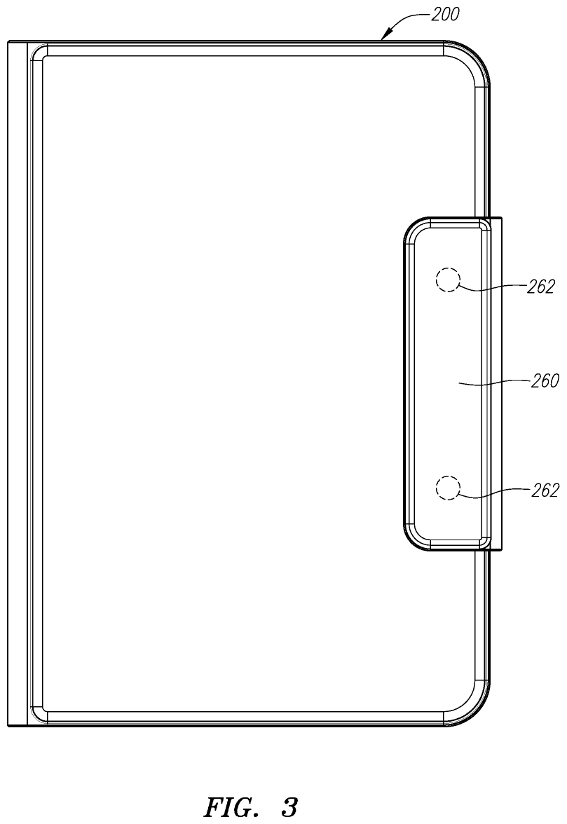

FIG. 3 is a front face view of the protective case 100 in the fully closed position showing the location of magnets 262 on a flap 260 that extends from one end of the front cover to magnetically attach to another end of the front cover. The flap 260 may extend from either or both sides of the front cover 200 of the protective case and magnetically attach to the other end of the front cover. In the illustrated embodiment, the flap 260 extends from the back end and when closed flaps over the front end of the cover 200.

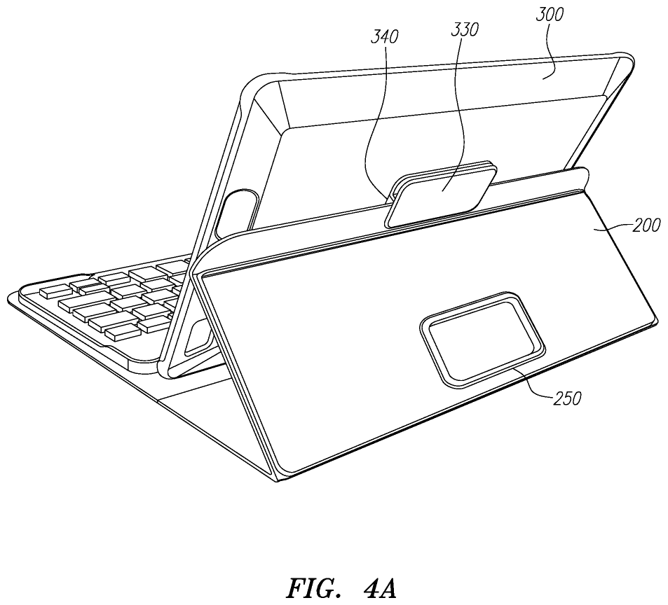

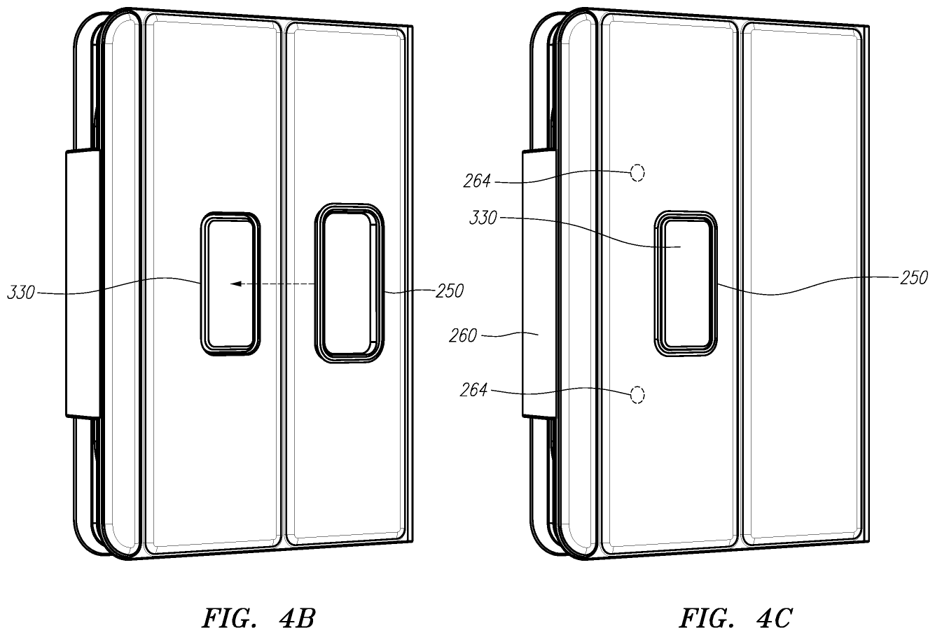

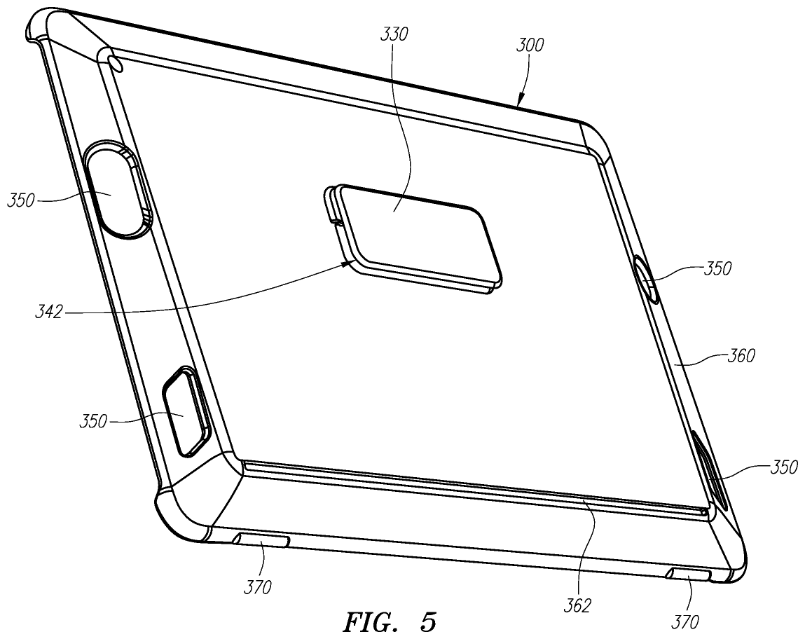

Corresponding magnets 264 with reverse or opposite polarization may be positioned in corresponding positions on the front cover underlying the flap 260 when the flap is in the closed position, as shown in phantom in FIG. 4C.

FIGS. 4A-4C are detailed illustrations of the latch ring 250 and its placement in the front cover 200, where the latch ring 250 is configured to receive the latch 330 on the back side 320 of the shell component 330 when the protective case 100 is in the fully closed position. FIG. 4A illustrates a perspective back view of the protective case 100 in the open use angled stand position with the end section 240 of the front cover 200 secured under the hook 340 that is integrated in the latch 330 formed on the back side 320 of the shell component 300. FIG. 4B is a partially disassembled backside perspective view of the fully closed case wherein the ring 250 is disassembled from the front cover component 200. FIG. 4C illustrates in phantom where the corresponding magnets 264 may be located on the region of the front cover 200 configured to mate with the flap 260 when the case is in the fully closed position.

The ring 250 provides firm support to the latch 330 to mitigate relative movement of the case components to further facilitate secured and maintained protection when the case is in the closed position.

FIG. 5 is a detailed back side perspective view illustration of the shell component 300 of the protective case 100. As illustrated therein the latch 330, which is located generally centrally on the back side 320 of the shell 300, includes a slot 342 formed on its underside that creates a hook 340 configured to receive one end section 240 of the front cover 200.

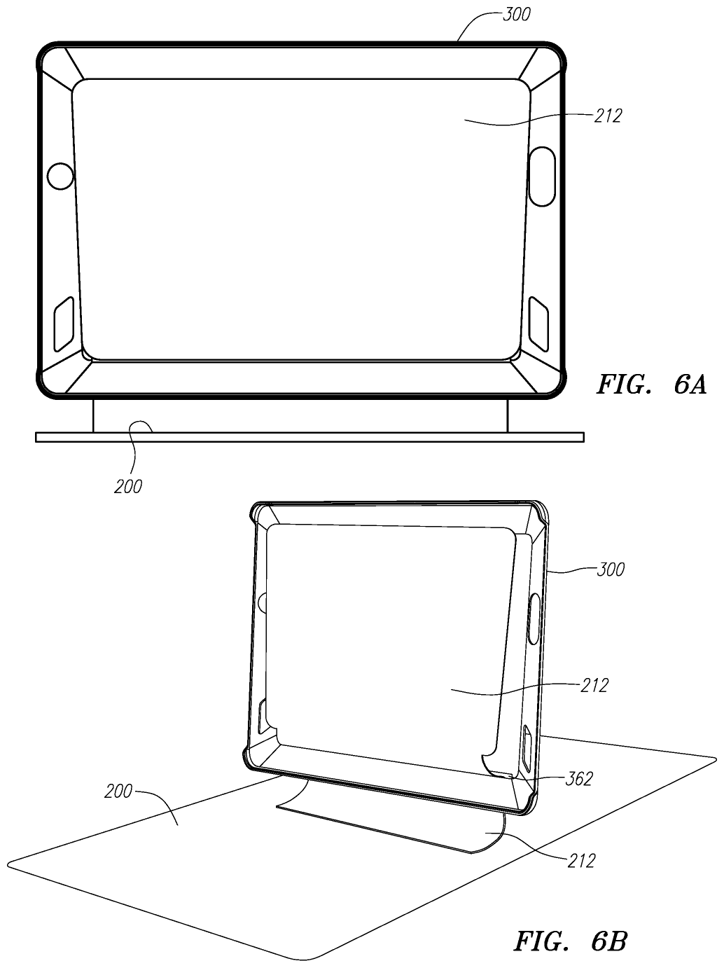

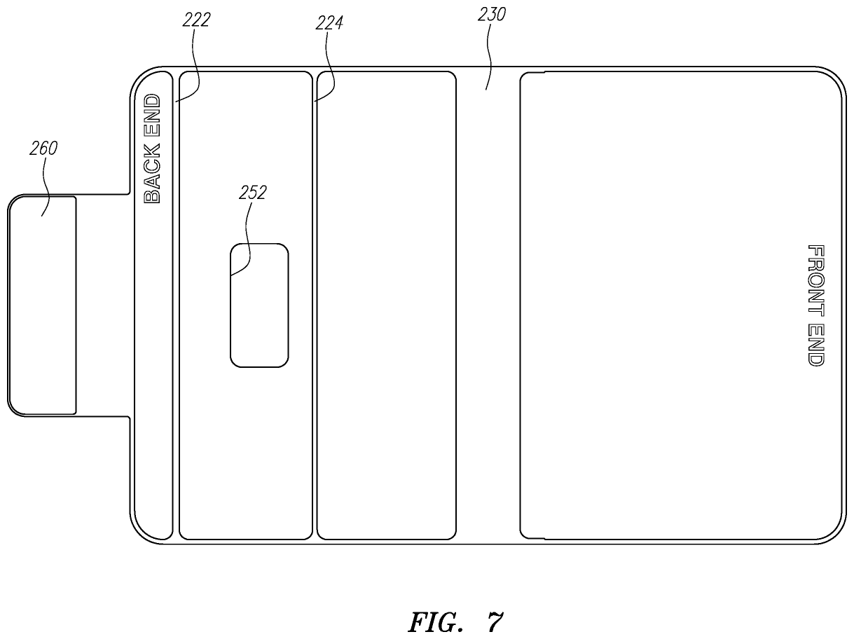

FIG. 5 also illustrates another longitudinally extending slot 362 formed on the bottom section 360 of the shell for insertion of a fabric lining layer 212 extending from the inner surface 210 of the front cover 200. The slot 362 and fabric lining layer 212 are depicted in detail in FIGS. 6A-6B.

FIG. 5 also illustrates various apertures 350 to facilitate control and use of the device and rubber feet 370 to provide a relatively high friction surface that is capable of engaging the inner surface 210 of the front cover 200 or the top of the keyboard 400 while mitigating slippage there between.

FIGS. 6A and 6B are simplistic illustrations of front and perspective views of the protective case 100 in the open position illustrating how the fabric lining layer 212 extends from the front cover 200 and is fed through the fabric liner slot 362 formed in the bottom region 360 of the shell 300 from the back side 320 of the shell for mounting onto the front face 310 of the panel that forms the shell component 300 and thereby attaches the shell 300 to the front cover 200.

The fabric lining layer 212 may be formed of any suitable material and may be heat sealed to the other components of the front cover 200 and/or shell 300 and/or may be adhesively or mechanically attached thereto. The fabric lining layer 212 in the preferred embodiment is flexible to allow for movement of the shell 300 relative to the front cover 200.

FIG. 7 is a line drawing illustrating the fabric layout of the front cover 200 of the case 100 including the flap 260, the various fold lines 222 and 224 and the flexible joint 230, and the latch aperture 252 that is dimensioned to receive and retain the latch ring 250.

Conditional language used herein, such as, among others, “can,” “might,” “may,” “e.g.,” and the like, unless specifically stated otherwise, or otherwise understood within the context as used, is generally intended to convey that certain embodiments include, while other embodiments do not include, certain features, elements and/or states. Thus, such conditional language is not generally intended to imply that features, elements and/or states are in any way required for one or more embodiments. The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list. Further, the term “each,” as used herein, in addition to having its ordinary meaning, can mean any subset of a set of elements to which the term “each” is applied.

While the above detailed description has shown, described, and pointed out novel features as applied to various embodiments, it will be understood that various omissions, substitutions, and changes in the form and details of the embodiments illustrated may be made without departing from the spirit of the disclosure. As will be recognized, certain embodiments of the inventions described herein may be embodied within a form that does not provide all of the features and benefits set forth herein, as some features may be used or practiced separately from others.

The previous description of the disclosed embodiments is provided to enable any person skilled in the art to make or use the invention disclosed herein. Although the various inventive aspects are disclosed in the context of certain illustrated embodiments, implementations, and examples, it should be understood by those skilled in the art that the invention extends beyond the specifically disclosed embodiments to other alternative embodiments and/or uses of the invention and obvious modifications and equivalents thereof. In addition, while a number of variations of various inventive aspects have been shown and described in detail, other modifications that are within their scope will be readily apparent to those skilled in the art based upon reviewing this disclosure. It should be also understood that the scope of this disclosure includes the various combinations or sub-combinations of the specific features and aspects of the embodiments disclosed herein, such that the various features, modes of implementation, and aspects of the disclosed subject matter may be combined with or substituted for one another. The generic principles defined herein may be applied to other embodiments without departing from the spirit or scope of the disclosure. Thus, the present disclosure is not intended to be limited to the embodiments shown herein but is to be accorded the widest scope consistent with the principles and novel features disclosed herein.

Similarly, the disclosure is not to be interpreted as reflecting an intent that any claim set forth below requires more features than are expressly recited in that claim. Rather, as the following claims reflect, inventive aspects may reside in a combination of fewer than all features of any single foregoing disclosed embodiment.

Each of the foregoing and various aspects, together with those set forth in the claims and summarized above or otherwise disclosed herein, including the figures, may be combined without limitation to form claims for a device, apparatus, system, method of manufacture, and/or method of use.

All references cited herein are hereby expressly incorporated by reference.

What is claimed is:

1. A protective case configured to reversibly receive a mobile device, said protective case comprising:
a shell configured to receive and retain the mobile device, wherein the shell comprises a back wall including an inner surface and an outer surface, wherein the inner surface is configured to cover at least a portion of a rear face of the mobile device, wherein the shell further comprises a slot formed through the shell and a latch extending from the outer surface, and wherein the latch comprises an integrated hook;
an outer cover comprising:
a front region configured to cover a front face of the tablet device when the case is in a fully closed position, wherein the front region includes a front panel; and
a back region configured to cover the outer surface of the back wall when the case is in a fully closed position, wherein the back region comprises an aperture defined by a ring dimensioned and positioned to receive the latch when the case is in the fully closed position; and
a fold line between the front region and the back region, enabling the front region to pivot relative to the back region; and
a connecting panel comprising:
a lining layer attached to the inner surface of the shell; and
an attachment portion attached to the inner surface of the outer cover between the front region and the back region;
wherein the portion of the connecting panel between the lining layer and the attachment portion passes through the slot in the shell.
